(19) United States
(12) Patent Application Publication
(10) Pub. No.: US 2019/0114701 A1
(43) Pub. Date: Apr. 18, 2019

(54) SMART MORTGAGE-BROKER CUSTOMER RELATIONSHIP MANAGEMENT SYSTEMS

(71) Applicants: Ashutosh Malaviya, san jose, CA (US); Puneeta Naik, fremont, CA (US)

(72) Inventors: Ashutosh Malaviya, san jose, CA (US); Puneeta Naik, fremont, CA (US)

(21) Appl. No.: 15/953,398

(22) Filed: Apr. 13, 2018

Related U.S. Application Data
(60) Provisional application No. 62/485,344, filed on Apr. 13, 2017.

(51) Int. Cl. G06Q 40/02; G06Q 30/00; G06Q 10/10

(52) U.S. Cl. CPC G06Q 40/02; G06Q 10/1097; G06Q 30/01

(57) ABSTRACT

In an aspect, a computer-implemented method useful for implementing a smart mortgage-broker customer relationship management system includes the step of providing a mortgage broker Customer relationship management (CRM) platform. The mortgage broker CRM is instantiated in a server system that implements mortgage broker CRM platform. The method includes the step of communicating a set of leads to the server system. The set of leads is obtained and communicated by a mortgage lender. The method includes the step of instantiating a CRM mobile-device application in a mobile device of the mortgage lender. The method includes the step of monitoring each action of the mortgage lender with the CRM mobile-device application with respect to each lead. The method includes communicating each action of the mortgage lender with the CRM mobile-device application with respect to each lead back to a mortgage-lender server system.

### CROSS REFERENCE TO RELATED APPLICATIONS

This application claims the benefit of priority from U.S. Provisional Application Ser. No. 62/485,344, which was filed on 13 Apr. 2017, which is expressly incorporated by reference herein in its entirety.

### BACKGROUND

Conventional systems for managing leads from mortgage lenders to local mortgage brokers may have limitations with respect to monitoring and analyzing mortgage broker actions with respect to the leads. Acquiring leads can be costly for the mortgage lenders. Mortgage lenders are also financially motivated to have as high a percentage of leads access the loan services offered by the mortgage lenders. Accordingly, mortgage lenders have an interest in providing their leads to the most active and successful mortgage brokers.

Customer relationship management (CRM) systems are technical tools that can be used to manage interactions with customers and/or prospects for mortgage brokers. Mortgage lenders can also monitor the mortgage brokers use of a CRM tool to monitor and analyze the activities of mortgage brokers. Accordingly, improvements to mortgage-service specialized CRM tools are needed to improve mortgage lender-mortgage broker-lead relationships.

### SUMMARY

In an aspect, a computer-implemented method useful for implementing a smart mortgage-broker customer relationship management system includes the step of providing a mortgage broker Customer relationship management (CRM) platform. The mortgage broker CRM is instantiated in a server system that implements mortgage broker CRM platform and is managed by the mortgage broker. The method includes the step of communicating a set of leads to the server system. The set of leads is obtained and communicated by a mortgage lender, and wherein the set of leads is stored in a database system communicatively coupled with the server system. The method includes the step of instantiating a CRM mobile-device application in a mobile device of the mortgage lender. The method includes the step of monitoring each action of the mortgage lender with the CRM mobile-device application with respect to each lead. The method includes the step of communicating each action of the mortgage lender with the CRM mobile-device application with respect to each lead back to a mortgage-lender server system.

### BRIEF DESCRIPTION OF THE DRAWINGS

FIG. 1 illustrates an example system of a mortgage-broker customer relationship management, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example process of monitoring mortgage broker activity with respect to a lead from a mortgage lender, according to some embodiments.

FIG. 5 illustrates another example process of monitoring mortgage broker activity with respect to a lead from a mortgage lender, according to some embodiments.

FIGS. 6-29 provide various example screen shots of some embodiments for implementing check-in application, according to some embodiments.

The Figures described above are a representative set and are not an exhaustive with respect to embodying the invention.

3

### DESCRIPTION

Disclosed are a system, method, and article of manufacture for smart mortgage-broker customer relationship management systems. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Broker can be a party that mediates between a buyer and a seller.

Cloud computing can involve deploying groups of remote servers and/or software networks that allow centralized data storage and online access to computer services or resources. These groups of remote serves and/or software networks can be a collection of remote computing services

Customer relationship management (CRM) system can be used to implement processes used by a company to manage interactions with customers and/or prospects.

Lender can be a bank and/or a non-bank lender.

Mobile device can include a handheld computing device that includes an operating system (OS), and can run various types of application software, known as apps. Example handheld devices can also be equipped with various context sensors (e.g. biosensors, physical environmental sensors, etc.), digital cameras, WI-FI, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

Mortgage can be a security interest in real property held by a lender as a. security for a debt, usually a loan of money. A mortgage can be the lender's security for a debt. It can be a transfer of an interest in land (or the equivalent) from the owner to the mortgage lender, on the condition that this interest will be returned to the owner when the terms of the mortgage have been satisfied or performed.

Mortgage broker can act as an intermediary who brokers mortgage loans on behalf of individuals or businesses.

### EXAMPLE EMBODIMENTS

Various smart mortgage-broker customer relationship management systems and processes are provided herein. A lender (e.g. a bank, other lender institution, etc.) can obtain various leads (e.g. a sales lead, a potential customer). The lead can be a homeowner. Leads can be identified using various predictive methodologies. Leads can be provided to mortgage brokers based on geographic regions, home cost, probability of a home owner placing the home for sale in a future period, etc. The lender can provide this information and a customer relationship management system to various mortgage brokers (and/or other real-estate professionals such as, but not limited to, real estate agents, etc.). The lender can then use the customer relationship management system to monitor the mortgage broker's activity with respect to the lead. The customer relationship management system can also include various functionalities and tools that assist the mortgage broker in contact leads and/or distributing marketing materials to said leads. The customer relationship management system can capture mortgage broker metrics with respect to leads. The customer relationship management system can communicate this information back to the lender that originated the lead. In this way, lenders can rank the efficacy and/or other attributes of various mortgage brokers in its organization.

### Example Computer Architecture and Systems

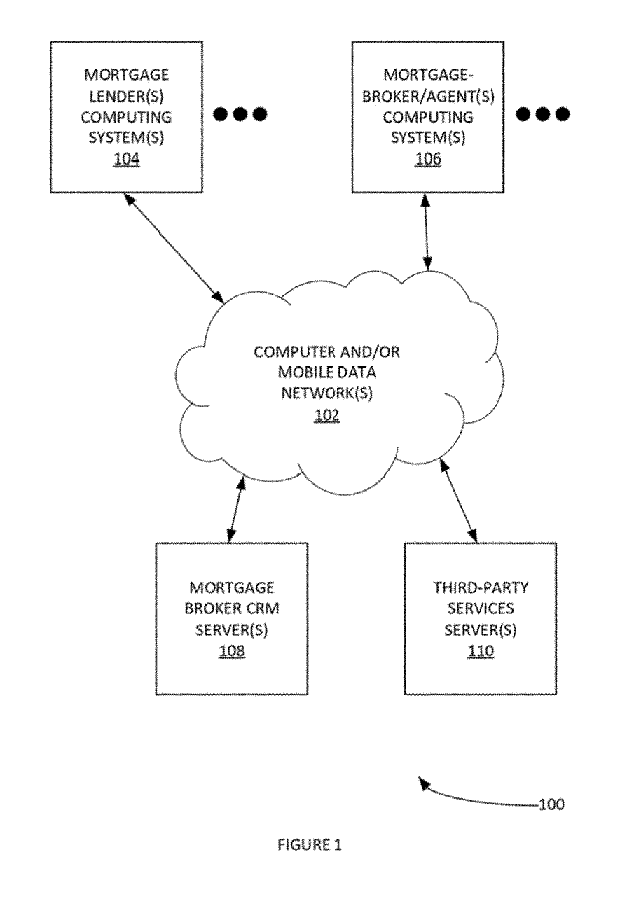

FIG. 1 illustrates an example system 100 of a mortgage-broker customer relationship management, according to some embodiments. System 100 can include various computer and/or cellular data networks 102. Computer and/or cellular data networks 102 can include the Internet, cellular data networks, local area networks, enterprise networks, etc. Networks 102 can be used to communicate messages and/or other information from the various entities of system 100.

Mortgage lender computing systems 104 can include a mortgage-broker CRM application. The lender-side version of the mortgage-broker CRM application can enable the lender to upload leads (e.g. lead location, contact information, home value, home data, etc.) to the mortgage-broker CRM system. The lender-side version of the mortgage-broker CRM application can enable the lender to monitor mortgage broker activity with respect to the provided leads. Lenders can communicate to mortgage brokers utilizing the lender-side version of the mortgage-broker CRM application as well. Additional, lender-side version of the mortgage-broker CRM application functionalities and screen-shot examples are provided infra. Mortgage lenders can perform various lead generation activities.

Mortgage broker(s)'s computing systems 108 can include another version of the mortgage-broker CRM application. Mortgage-broker CRM application can assist mortgage brokers in their management of lead. For example, mortgage-broker CRM application include marketing functionalities, lead interaction recording functionalities, etc. Example screen shots of mortgage-broker CRM application use cases are provided infra.

System 102 can include mortgage broker CRM server(s) 108. mortgage broker CRM server(s) 108 can communicate leads to mortgage broker(s)'s computing systems 108. mortgage broker CRM server(s) 108 can aggregate mortgage broker behavior. mortgage broker CRM server(s) 108 provide aggregated statistics for a set of specified mortgage brokers (e.g. based on geographic regions, home price, lead viability, etc.). Mortgage broker CRM server(s) 108 can provide dashboard interfaces to lenders (e.g. lender administrators, etc.). Lenders can upload leads to specified mortgage brokers using said dashboard. Lends can download mortgage broker metrics using said dashboard. Mortgage broker CRM server(s) 108 can provide alerts to lenders when a specified trigger metric is met. For example, an alert can be sent to a lender when a mortgage broker fulfills a lead contact quota. An alert can be sent to a lender when a mortgage broker doesn't contact a lead within a specified period of time.

Mortgage broker CRM server(s) 108 can provide dashboard interfaces to mortgage brokers. Mortgage broker CRM server(s) 108 can include web servers, geo-location systems, email servers, IM servers, database management systems, search engines, electronic payment servers, member management systems, administration systems, machine-learning systems, ranking systems, optimizations systems, text messaging systems, etc. Third-party services server(s) 114 can provided various third-party services (e.g. mapping services, marketing databases/services, geolocation services, online social networking services, machine-learning services, search engine services, etc.).

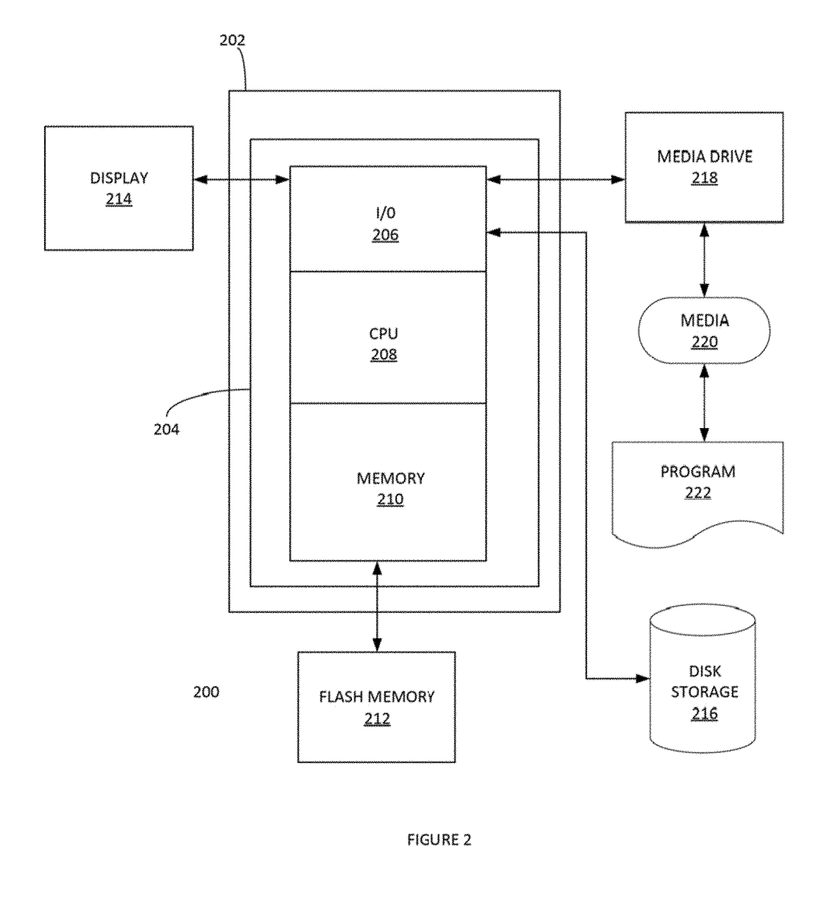

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carryout some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

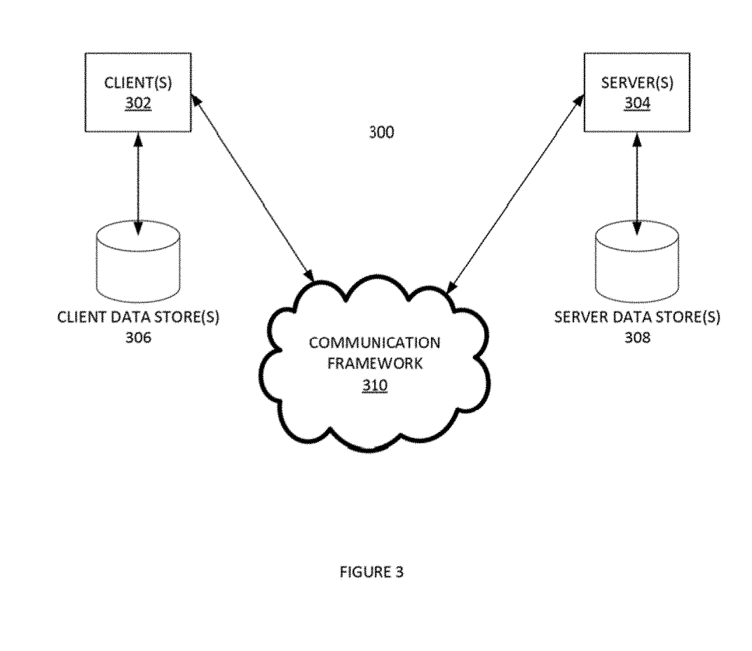

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### Exemplary Methods

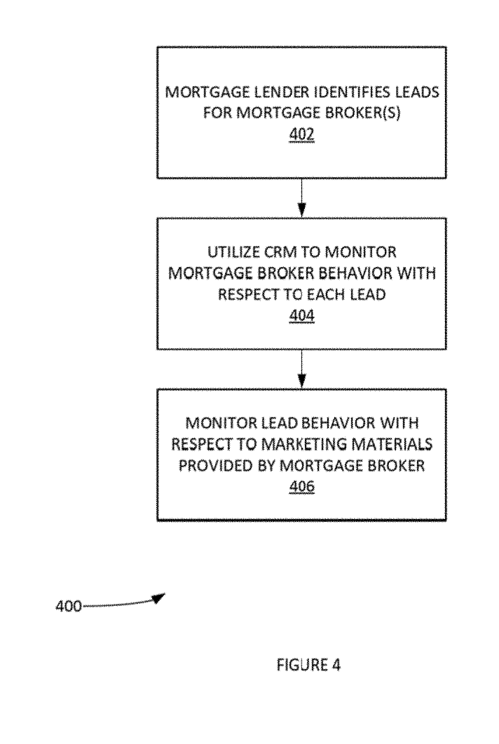

FIG. 4 illustrates an example process 400 of monitoring mortgage broker activity with respect to a lead from a mortgage lender, according to some embodiments. In step 402, a mortgage lender identifies leads for mortgage broker(s). The mortgage lender can push the leads to a CRM of the mortgage broker. The CRM of the mortgage broker can utilize a mobile-device application.

In step 404, the mortgage lender can utilize the CRM to monitor mortgage broker behavior with respect to each lead. For example, the mortgage broker's CRM and/or mobile-device application send the information back to a central server (e.g. Mortgage broker CRM server(s) 108) and/or other entity. The mortgage broker and/or lead status information can be aggregated, summarized and/or otherwise analyzed and presented to an administrator of the mortgage lender.

In step 406, the mortgage lender can monitor lead behavior with respect to marketing materials provided by mortgage broker. For example, the mortgage broker and/or other real-estate professional (e.g. a real-estate agent, marketing agents, etc.) can provide marketing materials to a lead. The marketing materials can include various codes that identify the lead. The leads behavior can be monitored and provided to the mortgage lender.

FIG. 5 illustrates another example process 500 of monitoring mortgage broker activity with respect to a lead from a mortgage lender, according to some embodiments. In step 502, process 500 can enable face to face prospecting with a smart CRM application. In step 504, process 500 can capture context of each prospecting interaction with a homeowner. In step 506, process 500 can track other mortgage broker action metrics. Prospecting is a term of contacting and interacting with qualified prospects such as lead whom the mortgage broker hopes to turn into a client. Activities such as networking, cold calling, referral generation fit here.

### Smart CRM And Check-In Application

It is noted that the various systems and methods used here can utilize a smart CRM. The smart CRM can filter data that is relevant to a real-estate agent (and/or mortgage broker, etc.). The check-in application can be a part of the smart CRM system. The check-in application can be implemented as a mobile-device application. The check-in application includes various display icons that make it easier for a user to navigate. The user can also be informed and given notifications on various actions.

The check-in application can enable a user (e.g. a real estate agent, a mortgage broker, etc.) to access contacts. A dashboard view can be presented. The dashboard view can include a percentage of completed check-ins (e.g. contact with leads, other home owners, contacts, etc.). A home owner can visit a website and become a lead by providing their respective information. Actions for a real estate agent to act on. For example, a home owner may request to be contacted by a real-estate agent. The home owner's information can be communicated to the real-estate agent via the check-in application. Alerts can be pushed to the real-estate agent's mobile device via the check-in application.

Various methods can be used to generate leads. For example, mailers that advertise the real-estate agent can be sent to home owners in a certain geographic region. In another example, on-line advertising can be used to generate leads for an agent. The context of the home owner's contact with these marketing methods can also be provided to the real-estate agent.

An activity stream of the real-estate agent's interaction with the home owner can be maintained and displayed to the real-estate agent. The activity stream can include the home owner's contact information (e.g. telephone number, email, etc.). Home owner's selling intent and/or other aspects of their engagement. If available, other information about the home owner (e.g. income, profession, work hours, etc.) can be provided. A likelihood-to-list score can be provided. The likelihood-to-list score can reflect a probability of the home owner placing the home on the market within a specified period of time. The leads can be classified based on a likelihood-to-list score and/or other variables. For example, a top 20% leads can be identified to the user.

All interactions that a real-estate agent has ever had with the home owners can be logged. This information can then be displayed in the activity stream. The activity stream can also include home owner actions. For example, the activity stream can begin with a home owner logging into a web page and providing contact information and requesting contact by a local real-estate agent. The home owner's information can be sent to an applicable real-estate agent. The real-estate agent can then visit the home owner. This information can also be logged into the activity stream along with any follow-up contact information.

Various home-owner nurture contacts can also be implemented. For example, emails can be periodically communicated to the home owner. Lead nurturing processes can be automatically performed and/or triggered based on various factors (e.g. a likelihood-to-sell score, home location, home value, etc.) Lead nurturing can be the process of developing relationships with home owners. It providing home owners/leads with relevant information about home ownership, real estate markets, sale of a home tips, etc. For example, an email addressed from the real-estate agent can be communicated to the home owner/lead once a week for eight weeks. Another monthly email with home-sales trends (e.g. number of homes sold, average square foot home price, etc.) in the lead's zip code can also be communicated to the lead. A lead can opt out of the emails.

A real-estate agent can check-in with the home owner. An example check-in can be door-knock visit with the home owner. The real-estate agent can gather various information from the homeowner during the in-person visit. This can be lead selling interest, name of person the real-estate agent spoke with, conversation quality, if listed with another real-estate agent, absentee owner; drop lead, etc. This information can be recorded in the real-estate's mobile device application and saved to his/her profile. The real-estate agent can take pictures/videos of the property and upload said pictures/videos using the check-in application. This information can be view on a web-page as well.

The check-in application can provide an action board. The action board can include list of activities that are scheduled for the real-estate agent to perform with respect to various leads. For example, the action board can include a list of calendared follow-ups that real-estate agent can perform (e.g. re-contact a lead, etc.). Door drop information can be recorded and/or scheduled. Events can be recorded and/or scheduled (e.g. food drives, charity events, holidays, etc.).

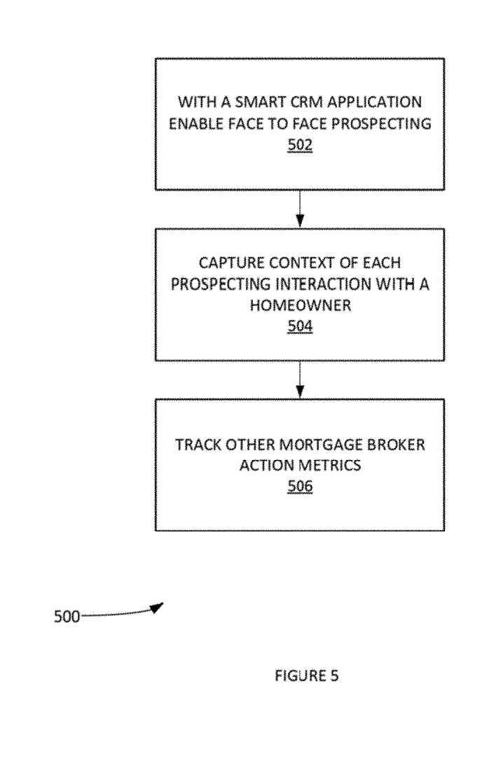

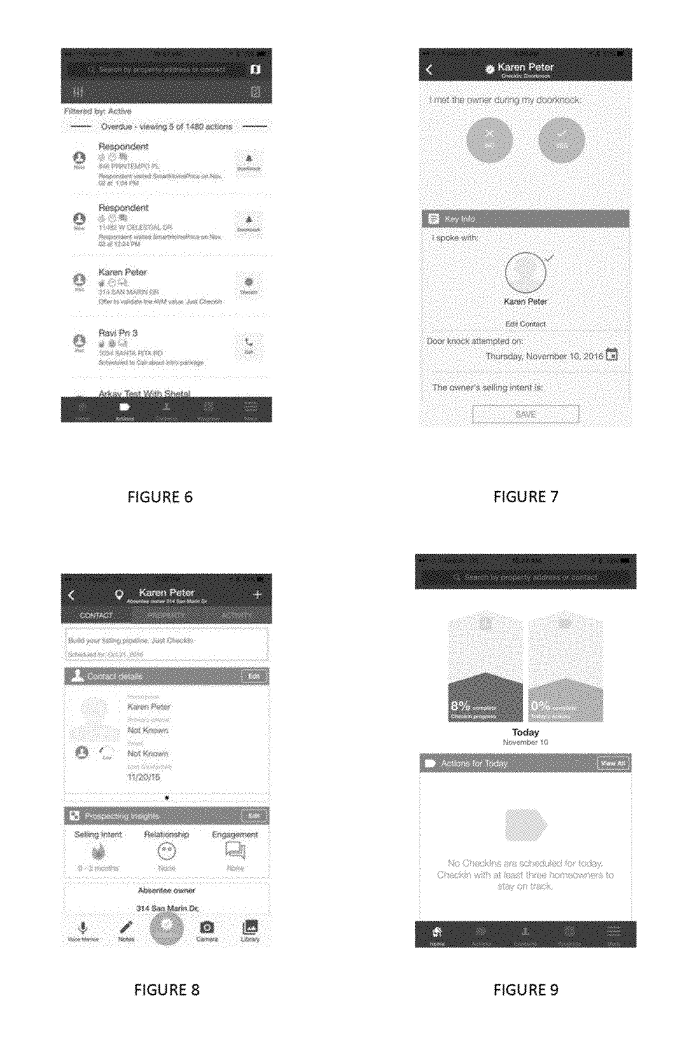

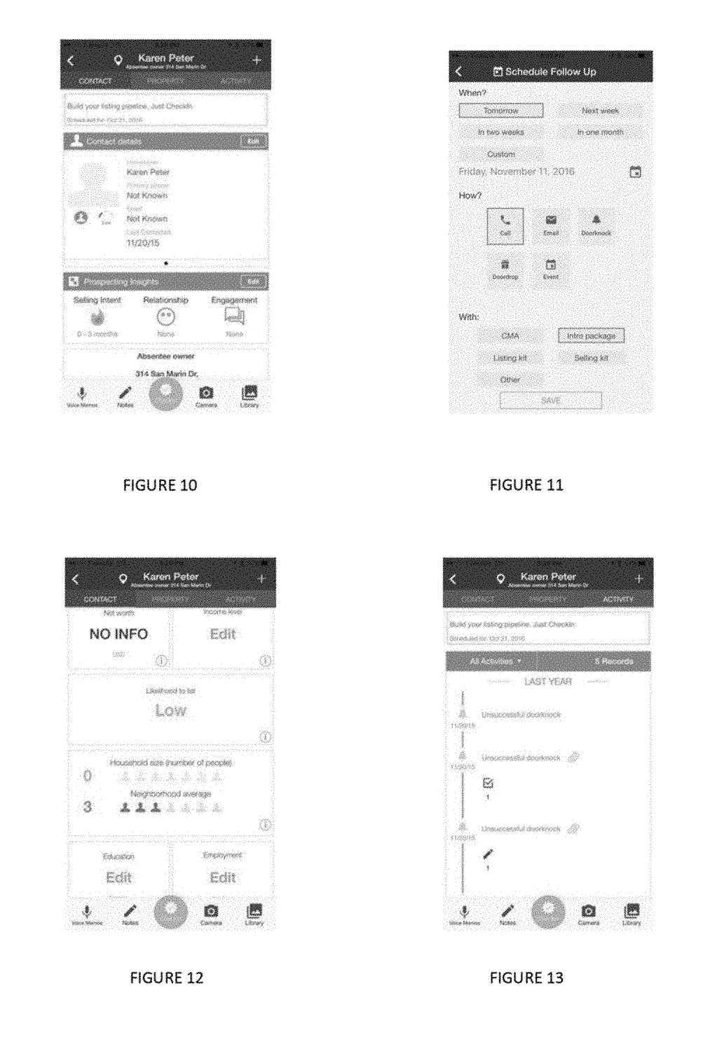

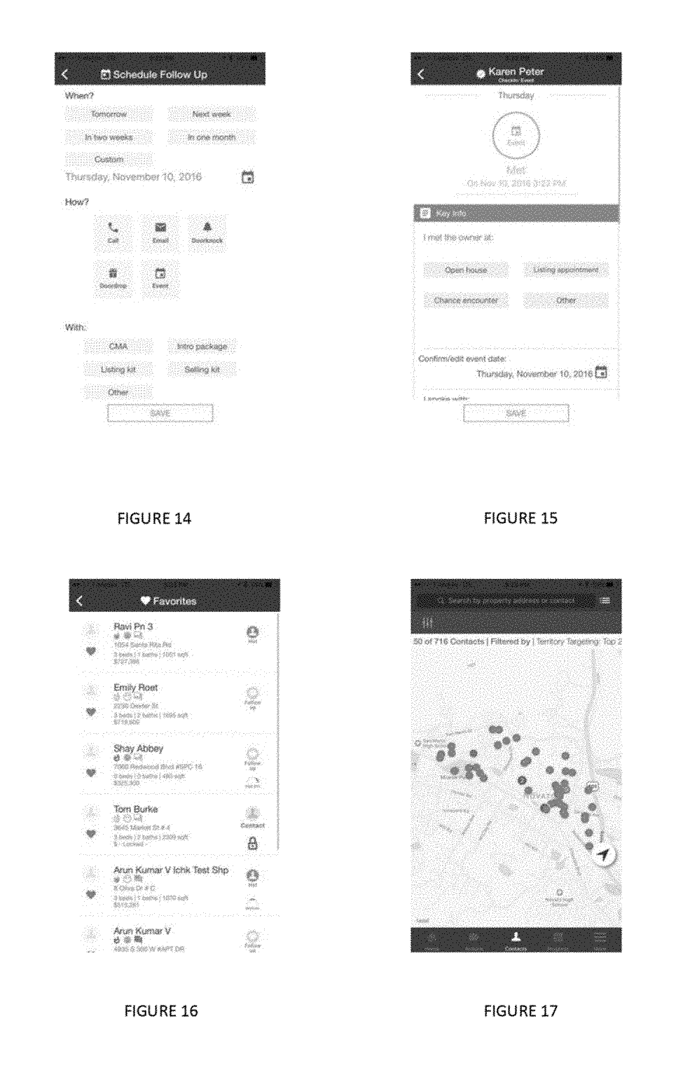

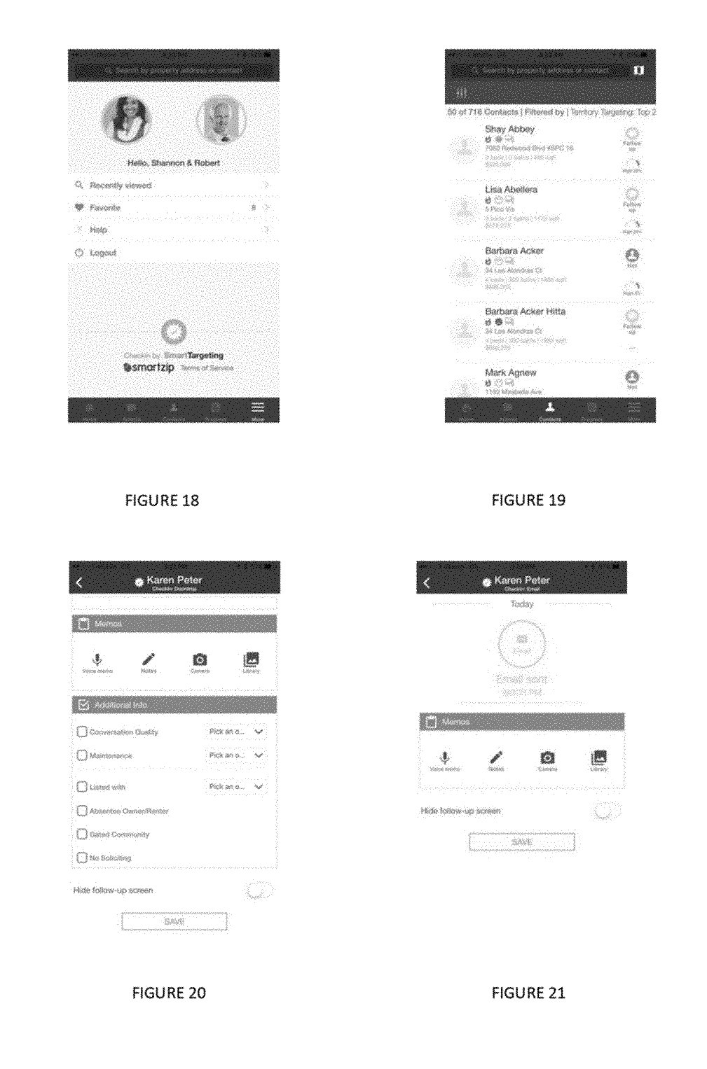

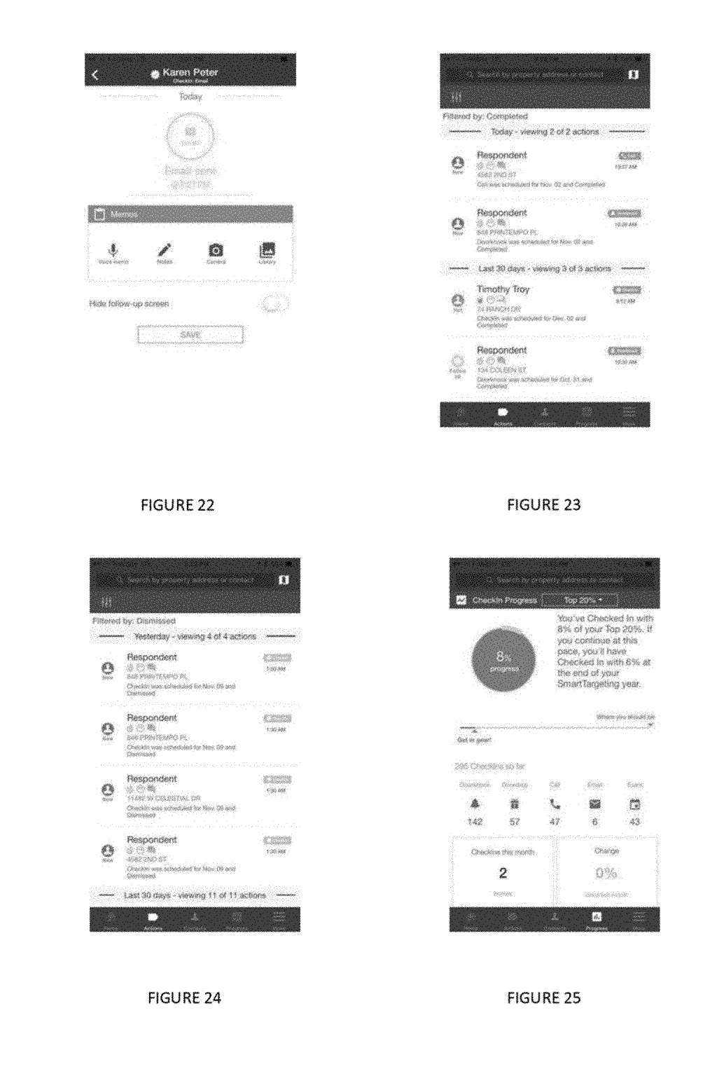

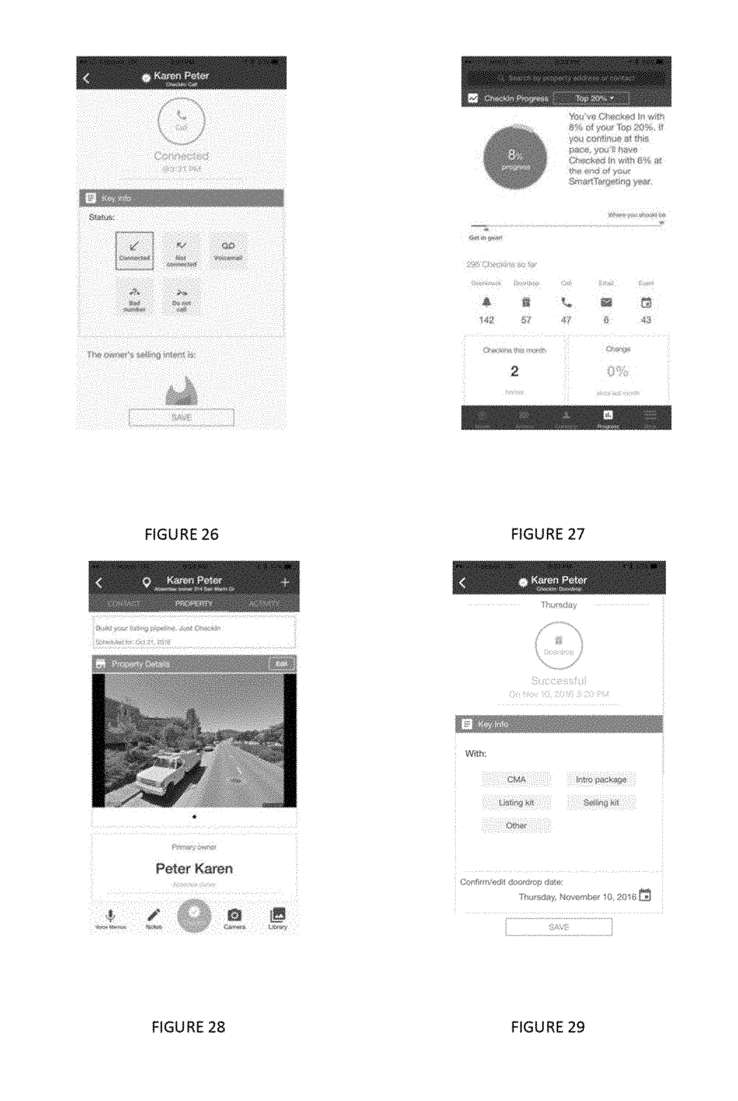

The check-in application can enable a real-estate agent to filter and/or rank lead contacts. Filtering attributes can include: home owner age, likelihood-to-sell, home size, number of beds/baths, home age, neighborhood attributes, delinquency status, home equity status, other demographic information, etc. A filter can include a map view. A filter can include a top percentage view (e.g. a top twenty percent view, etc.). FIGS. 6-29 infra, provide various example screen shots of some embodiments for implementing check-in application. More specifically, FIG. 6 illustrates an actions page accessed via navigation bar displays a user's scheduled actions to complete. Various overdue and/or upcoming actions are also displayed. FIGS. 7, 15, 20, 21, 22, 26 and 29 illustrates a check in with homeowner display via a selected/scheduled check-in action. A user can fill out a form with information such as, inter alia: the individual(s) they spoke with, date, selling intent and additional information. FIGS. 8 and 10 illustrate a scheduled action that appears on an action board and contact page as a banner. FIG. 9 illustrates a landing page dashboard that displays a user's scheduled actions to be completed on a specified day. FIGS. 11 and 14 illustrates a follow up with homeowner after a check-in has been completed by filling out form. FIG. 12 illustrates a likelihood to list that is based on a prediction analytics process (e.g. top twenty percent, medium, low, etc.). FIG. 13 illustrates an activity stream that connects with homeowners and includes various data points which were entered by user. FIG. 16 illustrates various user selected favorites (e.g. from Mobile/SaaS). FIG. 17 illustrates a map view of contacts that are color-coded by predictions (top twenty percent-red, medium-blue, low-gray). FIG. 18 illustrates a menu for additional items. FIG. 19 illustrates a check-in application that enables a user to click on the contacts page to view, filter, map, create bulk actions to listed contacts. FIG. 23 illustrates a list of completed actions. FIG. 24 illustrates list of dismissed actions. FIGS. 25 and 27 illustrate a check-in progress board view including total number of check-ins completed. FIG. 28 illustrates various views of property details of given contact.

A time for a user to contact a lead can be calculated as follows. The time to contact a lead in the smart CRM can be based on the following rules. (1) If the lead defined as a “Hot Lead” (e.g. an individual leaves a phone number with a real-estate lead service, etc.) and (a) is due call within thirty minutes; and a door knock within twenty-four hours (2) if the lead is defined as a “New Lead” (e.g. an individual who has interacted with the smart CRM for the first time, etc.): (a) the new lead is due call within thirty minutes; and (b) a door knock within fourteen days.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computer-implemented method useful for implementing a smart mortgage-broker customer relationship management system, the method comprising:
providing a mortgage broker Customer relationship management (CRM) platform, wherein the mortgage broker CRM is instantiated in a server system that implements mortgage broker CRM platform and is managed by the mortgage broker;
communicating a set of leads to the server system, wherein the set of leads is obtained and communicated by a mortgage lender, and wherein the set of leads is stored in a database system communicatively coupled with the server system;
instantiating a CRM mobile-device application in a mobile device of the mortgage lender;
monitoring each action of the mortgage lender with the CRM mobile-device application with respect to each lead; and
communicating each action of the mortgage lender with the CRM mobile-device application with respect to each lead back to a mortgage-lender server system.

2. The computer-implemented method of claim 1:
wherein the CRM mobile-device application comprises a check-in application, and
wherein the CRM mobile-device application provides a user interface that comprises a map that displays a set of icons for the mortgage broker to navigate.

3. The computer-implemented method of claim 2:
wherein the check-in application displays notifications on an action board, wherein the action board displays a list of activities that are scheduled for the mortgage broker to perform with respect to a specified subset of leads leads.

4. The computer-implemented method of claim 3:
wherein the action board comprises a calendaring application that displays a calendar of the action items.

5. The computer-implemented method of claim 4:
wherein the list of action items comprises a list of lead follow-up actions that are automatically calendared by the calendaring application,
wherein the check-in application automatically records a mortgage brokers conversation with a lead in a face-to-face interaction between the mortgage broker and the lead when the mortgage broker visits a lead's home.

6. The computer-implemented method of claim 5:
wherein the check-in application enables the mortgage broker to filter and rank lead contacts, and
wherein the check-in application generates a within-application map view and a top percentage range view of a filter set of leads.

7. The computer-implemented method of claim 5:
wherein the mortgage-lender server system aggregates and summarizes the data from each action of the mortgage lender that is received from the CRM mobile-device application.

8. A computerized database management system useful for implementing a smart mortgage-broker customer relationship management system comprising:
at least one processor configured to execute instructions;
a memory containing instructions when executed on the processor, causes the at least one processor to perform operations that:
provide a mortgage broker Customer relationship management (CRM) platform, wherein the mortgage broker CRM is instantiated in a server system that implements mortgage broker CRM platform and is managed by the mortgage broker;
communicate a set of leads to the server system, wherein the set of leads is obtained and communicated by a mortgage lender, and wherein the set of leads is stored in a database system communicatively coupled with the server system;
instantiate a CRM mobile-device application in a mobile device of the mortgage lender;
monitor each action of the mortgage lender with the CRM mobile-device application with respect to each lead; and
communicate each action of the mortgage lender with the CRM mobile-device application with respect to each lead back to a mortgage-lender server system.

9. The computer-implemented system of claim 8:
wherein the CRM mobile-device application comprises a check-in application, and
wherein the CRM mobile-device application provides a user interface that comprises a map that displays a set of icons for the mortgage broker to navigate.

10. The computer-implemented system of claim 9:
wherein the check-in application displays notifications on an action board, wherein the action board displays a list of activities that are scheduled for the mortgage broker to perform with respect to a specified subset of leads.

11. The computer-implemented system of claim 10:
wherein the action board comprises a calendaring application that displays a calendar of the action items.

12. The computer-implemented system of claim 11:
wherein the list of action items comprises a list of lead follow-up actions that are automatically calendared by the calendaring application,
wherein the check-in application automatically records a mortgage brokers conversation with a lead in a face-to-face interaction between the mortgage broker and the lead when the mortgage broker visits a lead's home.

13. The computer-implemented system of claim 12:
wherein the check-in application enables the mortgage broker to filter and rank lead contacts, and
wherein the check-in application generates a within-application map view and a top percentage range view of a filter set of leads.

14. The computer-implemented system of claim 13:
wherein the mortgage-lender server system aggregates and summarizes the data from each action of the mortgage lender that is received from the CRM mobile-device application.
